(19) United States
(12) Patent Application Publication
(10) Pub. No.: US 2004/0171360 A1
(43) Pub. Date: Sep. 2, 2004

(54) Broadcast reception circuit, broadcast reception apparatus, and broadcast reception method

(75) Inventors: Masami Oosawa, Kumagaya-shi (JP); Takeshi Tokunaga, Fukaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/740,534

(22) Filed: Dec. 22, 2003

(30) Foreign Application Priority Data
Feb. 27, 2003 (JP) 2003-051410

(51) Int. Cl. H04B 17/02

(52) U.S. Cl. 455/136; 455/140

(57) ABSTRACT

A reception circuit is designed to be free from the influence of noise from a Zener diode. This circuit may have a selection unit which selects a desired broadcast signal in accordance with control signal Vt, an amplifier unit which amplifies the broadcast signal, a booster circuit which increases power supply potential B+ to generate an increased potential, a control unit which is responsive to the increased potential, and generates a control signal used to designate a desired broadcast signal so as to supply the control signal to the selection unit, and Zener diode ZD which has Zener voltage Vz larger than maximum potential Vtmax of the control signal. This diode ZD suppresses or limits the increased potential to be equal to or lower than the Zener voltage. Since the Zener diode does not bring about any breakdown operation in a steady state, a noise-free reception can be assured.

### CROSS-REFERENCE TO RELATED APPLICATIONS

This application is based upon and claims the benefit of priority from the prior Japanese Patent Application No. 2003-051410, filed Feb. 27, 2003, the entire contents of which are incorporated herein by reference.

### BACKGROUND OF THE INVENTION

1. Field of the Invention

The present invention relates to a broadcast reception circuit and, more particularly, to a broadcast reception circuit which tunes using a tuning control signal based on an increased potential obtained by increasing a power supply potential, a broadcast reception apparatus, and a broadcast reception method.

2. Description of the Related Art

In recent years, broadcast reception apparatuses of broadcast signals have been downsized, and products which are incorporated in, e.g., cable modems as communication units have been developed and manufactured. In such communication unit, a broadcast signal tuning circuit is also downsized, and is controlled by a digital signal. For example, 5 V as a power supply potential is increased to an increased potential of, e.g., 30 V using a DC-DC converter or the like, and a control signal having an appropriate potential corresponding to the frequency of a desired broadcast station is generated using a transistor controlled by a PLL (Phase Locked Loop) circuit, which is controlled by a digital signal, on the basis of the increased potential. This control signal is supplied to a variable capacitance (capacitance is variable) diode of a variable BPF (Band Pass Filter) or oscillation circuit to control it, thus tuning a desired broadcast station from an RF (Radio Frequency) signal.

As the tuning control signal of the variable capacitance diode included in the variable BPF or the oscillation unit, a potential obtained by increasing the power supply potential of 5 V or the like using the DC-DC converter or the like is used since the power supply potential is insufficient due to a broad frequency band as a tuning range. However, when the increased potential from the DC-DC converter is applied to the aforementioned variable capacitance diode as an excessive value during, e.g., a transient period upon startup, it may destroy the variable capacitance diode. Hence, protection is required.

As related prior art, an example that uses a Zener diode to control the voltage of a DC-DC converter circuit (e.g., Jpn. Pat. Appln. KOKAI Publication No. 2001-103738) is known. In this prior art, since the Zener diode is used at the output of the DC-DC converter circuit, the output voltage can be suppressed to a constant value by the breakdown voltage of the Zener diode.

However, in the aforementioned prior art, since the constant output voltage is obtained by the value (e.g., 12 V) of the breakdown voltage of the Zener diode, the Zener diode always makes a breakdown operation in a steady state. Therefore, noise is always generated from the Zener diode in the steady state. As a result, in a broadcast reception circuit or the like, which handles an RF signal as a high-frequency signal, such noise adversely influences an RF circuit, and a satisfactory reception state cannot be obtained. Furthermore, when the broadcast reception circuit is built in, e.g., a cable modem, the reception unit must be downsized very much in terms of its structure while executing digital control. However, the prior art cannot meet such downsizing requirement.

### BRIEF SUMMARY OF THE INVENTION

A broadcast reception circuit, according to an embodiment of the invention comprises a selection unit configured to receive an RF (Radio Frequency) signal, and to select a desired broadcast signal from the received RF signal in accordance with a predetermined control signal being input; an amplifier unit which is formed in an integrated circuit and is configured to amplify the selected broadcast signal; a booster unit configured to receive a power supply potential, and to increase the input power supply potential to output an increased potential; a control unit which is formed in the integrated circuit, and is configured to generate the control signal for designating the desired broadcast signal so as to supply the control signal to the selection unit; and a Zener diode which has a Zener voltage value larger than a maximum value of a potential of the control signal, and is configured to suppress or limit the increased potential supplied from the booster unit to be not more than the Zener voltage value.

In the broadcast reception circuit, for example, the selection unit that tunes a broadcast signal uses an increased potential of, e.g., 30 V obtained by increasing a power supply potential of, e.g., 5 V by a DC-DC converter circuit, so as to use, e.g., a variable capacitance diode. The control unit generates a control signal of a desired potential based on the increased potential increased by the booster unit, so as to apply a filtering process of the frequency of a desired broadcast station to the RF signal, and to generate an oscillation signal corresponding to this frequency.

At this time, when the increased potential by the DC-DC converter circuit temporarily becomes an excessive potential during a transient period or the like, it may destroy the aforementioned variable capacitance diode. Hence, the variable capacitance diode must be protected by any means such as a Zener diode. However, the Zener diode of the embodiment has Zener voltage Vz larger than maximum potential Vtmax of the control signal, and is used to release the excessive potential during the transient period or the like upon starting up a power supply to the ground potential. Therefore, since the breakdown operation of the Zener diode is not always made in a steady state unlike in a conventional apparatus, noise can be prevented from being generated by the Zener diode and, at the same time, for example, the variable capacitance diode in the selection unit can be protected from an excessive voltage. Furthermore, satisfactory reception free from the influence of noise due to the breakdown operation of the Zener diode can be assured.

Furthermore, in an embodiment of the present invention, an IF amplifier which disturbs a size reduction of the broadcast reception circuit, a PLL circuit which serves as the aforementioned control circuit, and so on are integrally formed as one integrated circuit. Hence, since the broadcast reception circuit can be downsized, a high-quality modem with a tuner function can be provided by building a reception unit in a digitally controlled cable modem.

### BRIEF DESCRIPTION OF THE SEVERAL VIEWS OF THE DRAWING

FIG. 1 is a block diagram showing an example of a reception circuit according to the present invention;

FIG. 2 is a block diagram showing another example of the reception circuit according to the present invention;

FIG. 3 is a block diagram showing an example wherein a DDC of the reception circuit according to the present invention is formed in an integrated circuit;

FIG. 4 is a block diagram showing an example wherein a DDC and resistors of the reception circuit according to the present invention are formed in an integrated circuit;

FIG. 5 is a block diagram showing an example wherein a DDC, resistors, and a Zener diode of the reception circuit according to the present invention are formed in an integrated circuit;

FIG. 6 is a schematic block diagram showing the arrangement of an example of a broadcast reception apparatus according to the present invention;

FIG. 7 is a perspective view showing the outer appearance of an example of a PC to be connected to the broadcast reception apparatus according to the present invention; and

FIG. 8 is a perspective view showing an example of a board of the broadcast reception apparatus according to the present invention.

### DETAILED DESCRIPTION OF THE INVENTION

A broadcast reception circuit, broadcast reception apparatus, and broadcast reception method according to an embodiment of the present invention will be described in detail hereinafter with reference to the accompanying drawings.

<Broadcast Reception Circuit According to This Invention>

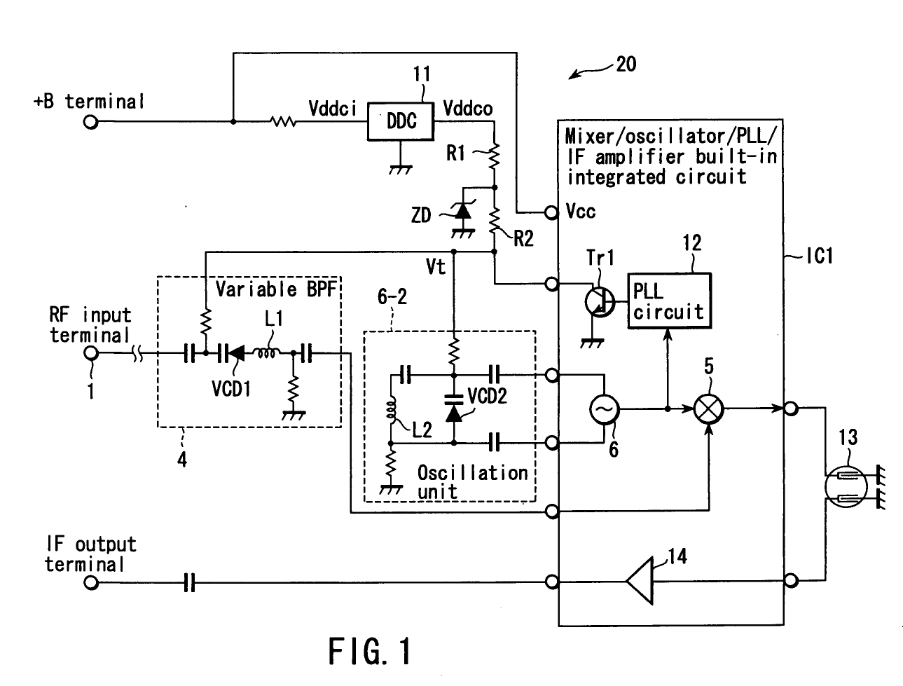

A broadcast reception circuit according to the present invention will be described first with reference to the accompanying drawings. FIG. 1 is a block diagram showing a broadcast reception circuit according to the present invention.

(Arrangement)

Broadcast reception circuit 20 according to the present invention has RF input terminal 1 which receives an RF (Radio Frequency) signal from an antenna or distributor, variable BPF (Band Pass Filter) 4 which is connected to RF input terminal 1 and receives the RF signal, and integrated circuit IC1 which receives the output from variable BPF 4 and incorporates a mixer/oscillator/PLL/IF amplifier, as shown in FIG. 1. Furthermore, circuit 20 has DC-DC converter (DDC) 11 which is connected to an internal power supply terminal of, e.g., +5 V via a resistor or the like, resistor R1 connected to the output terminal of DDC 11, Zener diode ZD, one terminal of which is connected to the other terminal of resistor R1, and the other terminal of which is connected to the ground potential, and resistor R2 which is connected to the other terminal of resistor R1.

The other terminal of resistor R2 is connected to integrated circuit IC1, and also to variable BPF 4 and oscillator unit 6-2. One output terminal of integrated circuit IC1 is connected to an IF (Intermediate Frequency) output terminal via a capacitor. Furthermore, another output terminal of integrated circuit IC is connected to SAW filter 13, and the output terminal of SAW filter 13 is connected to an input terminal of integrated circuit IC1.

Furthermore, in variable BPF 4, variable capacitance diode VCD1 is connected to an input terminal, to which RF input terminal 1 is connected, via capacitors, and receives tuning control voltage Vt from resistor R2 on its cathode side. One terminal of inductor L1 is connected to the anode of diode VCD1. The other terminal of inductor L1 is connected to the ground via a resistor and also to the output terminal via a capacitor.

Oscillator unit 6-2 has variable capacitance diode VCD2 which receives tuning control voltage Vt from resistor R2 at its cathode side. A series circuit of a capacitor and inductor L2 is connected between the anode and cathode of diode VCD2. Furthermore, the anode of diode VCD2 is connected to the ground. The anode and cathode of diode VCD2 are respectively connected as oscillation output terminals to input terminals of integrated circuit IC1 via capacitors.

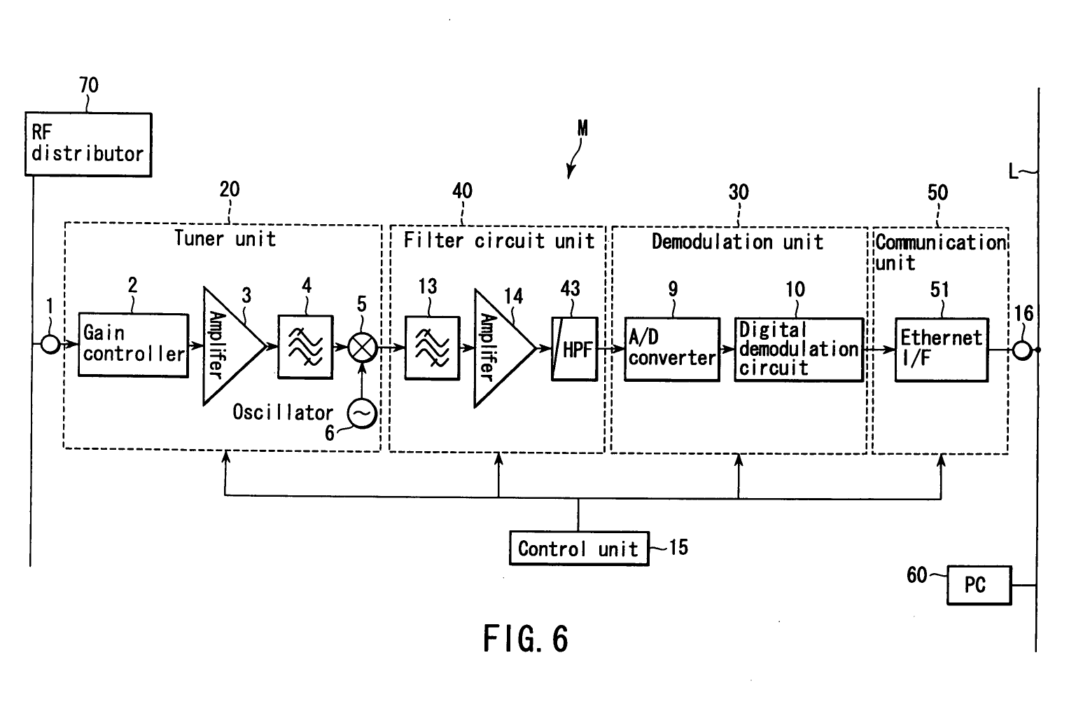

Furthermore, integrated circuit IC1 receives power supply potential Vcc from the power supply terminal. Integrated circuit IC1 further has transistor Tr1 and PLL (Phase Locked Loop) circuit 12 which supplies a control signal to the base of transistor Tr1. Transistor Tr1 and PLL circuit 12 serve as a control unit for determining tuning control voltage Vt. Transistor Tr1 receives the increased potential from the other terminal of resistor R2 via a terminal, and a tuning control voltage (Vt) is determined in accordance with the operation of transistor Tr1. PLL circuit 12 receives a code signal corresponding to a desired broadcast station from control unit 15 (to be described later using FIG. 6) via a connection (not shown). PLL circuit 12 specifies desired tuning control voltage Vt so as to form a phase locked loop in accordance with the code signal and to tune a broadcast signal of a desired broadcast station.

Note that the desired broadcast signal may include television broadcast signals of, e.g., VHF (Very High Frequency), UHF (Ultra High Frequency), satellite broadcast, and the like, radio broadcast signals of, e.g., FM (Frequency Modulation) broadcast, AM (Amplitude Modulation) broadcast, and the like, a modulated signal of digital communication data of, e.g., the Internet, or broadcast signals of other formats.

Moreover, integrated circuit IC1 has oscillator 6 which receives an oscillation signal from oscillation unit 6-2. The output from oscillator 6 is supplied to mixer 5 and PLL circuit 12. Furthermore, the output from variable BPF 4 is similarly supplied to mixer 5 via a terminal. The output of mixer 5 is connected to SAW filter 13 externally connected to integrated circuit IC1. Also, IF amplifier 14 that receives the output from SAW filter 13 is provided, and the output from IF amplifier 14 is output to the output terminal of integrated circuit IC1.

(Operation)

Broadcast reception circuit 20 according to the present invention with the above arrangement operates as follows. Referring to FIG. 1, transistor Tr1, which is driven by PLL circuit 12 in integrated circuit IC1 that incorporates the mixer/oscillator/PLL/IF amplifier, generates tuning control signal Vt. That is, when a code signal that means designation of a desired broadcast station is supplied from control unit 15 shown in FIG. 6 (to be described later) or the like to PLL circuit 12, PLL circuit 12 controls transistor Tr1 by a control signal with a value corresponding to the code signal, thereby generating tuning control signal Vt according to the frequency of the desired broadcast station. The capacitance of variable capacitance (capacitance is variable) diode VCD2 in oscillation unit 6-2 connected to oscillator 6 in integrated circuit IC1 is changed in accordance with tuning control signal Vt. Oscillator 6 in integrated circuit IC1 oscillates at a desired resonance frequency under the control of the PLL circuit by series resonance of variable capacitance diode VCD2 and inductor L2. At this time, a voltage used to generate tuning control signal Vt is an increased potential obtained by increasing input voltage Vddci of DC-DC converter circuit 11, which is supplied from a +B terminal, to output voltage Vddco of the DC-DC converter circuit, by DC-DC converter circuit 11.

On the other hand, an RF signal input from RF input terminal 1 is supplied to variable capacitance diode VCD1 via capacitors. Tuning control signal Vt changes the capacitance of variable capacitance diode VCD1 in variable-frequency BPF 4. At this time, variable capacitance diode VCD1 and inductor L1 are designed to tune in a desired reception channel so as to receive only a desired broadcast signal. The RF signal is filtered to only signal components that mainly include the desired broadcast signal, and is then input to the input terminal of integrated circuit IC1.

In integrated circuit IC1, an oscillation signal oscillated by oscillator 6 and a signal input to integrated circuit IC1 via variable-frequency BPF 4 are input to mixer 5 in integrated circuit IC1. These input signals are converted into a frequency as the difference between the signal frequency oscillated by the oscillator 6 and the RF signal input to integrated circuit IC1, and the converted signal is output from integrated circuit IC1 as an IF (Intermediate Frequency) signal.

This IF signal is input to SAW filter 13 connected to integrated circuit IC1 to remove unwanted signal components such as signal components of neighboring channels and the like. Then, the filtered IF signal is input to integrated circuit IC1 again. The IF signal input to integrated circuit IC1 is amplified to a desired amplitude via IF amplifier 13 in integrated circuit IC1. After that, the IF signal is output from integrated circuit IC1, and is supplied to the IF output terminal via a capacitor and the like.

The IF signal is then supplied from this IF output terminal to the input terminal of filter circuit unit in FIG. 6 (to be described later), and undergoes a demodulation process and the like to be converted into a modulated signal of a video signal, audio signal, or digital communication data.

(Function of Zener Diode ZD According to Embodiment of This Invention)

In broadcast reception circuit 20 according to the embodiment with the above arrangement and operation, it is indispensable that tuning control voltage Vt must be a high DC voltage since it is filtered by variable capacitance diodes VCD1 and VCD2 of variable BPF 4 and oscillation unit 6-2 or is used to oscillate a corresponding oscillation signal, as described above. For example, a voltage as high as 30 V to 15 V must be applied as voltage Vt. If the power supply potential of broadcast reception circuit 20 is, e.g., 5 V, variable capacitance diodes VCD1 and VCD2 cannot be controlled directly using such power supply voltage. Hence, the high voltage must be applied as an increased potential after a boosting process using DC-DC converter circuit 11 or the like.

In practice, when an inexpensive DC-DC converter circuit is used so as to minimize the cost of broadcast reception circuit 20, output voltage Vddco of the DC-DC converter circuit suffers a large variation width. In order to assure maximum voltage Vtmax required for tuning in consideration of this large variation width, a DC-DC converter circuit which has a very high variation maximum voltage of output voltage Vddco must be designed.

During a period immediately after the power supply of a cable modem is turned on and before the PLL operation starts, i.e., a transient period, transistor Tr1 is OFF, and this output voltage Vddco is applied to variable capacitance diodes VCD1 and VCD2 as output voltage Vt that has undergone voltage drops of protection resistors R1 and R2. If output voltage Vt at that time is equal to or higher than reverse withstand voltage Vr of variable capacitance diodes VCD1 and VCD2, it may destroy or deteriorate variable capacitance diodes VCD1 and VCD2.

In broadcast reception circuit 20, Zener diode ZD is inserted between the DC-DC converter circuit output and transistor Tr1 to release such excessive output voltage Vt to the ground side as needed, thereby suppressing control voltage Vt. At this time, Zener voltage Vz of Zener diode ZD is selected to satisfy:

Vr>Vz>Vtmax

Note that the voltage drop due to resistor R2 is omitted since it is negligible.

By selecting Zener voltage Vz to be such value, even when output voltage Vddco of DC-DC converter circuit 11 is higher than reverse withstand voltage Vr of Zener diode ZD, control voltage Vt is decreased to Zener voltage Vz due to the breakdown characteristics of Zener diode ZD. Therefore, in broadcast reception circuit 20 according to the present invention, since a voltage equal to or higher than reverse withstand voltage Vr is never applied to variable capacitance diodes VCD1 and VCD2, variable capacitance diodes VCD can be protected from any destruction and deterioration.

When reception circuit 20 shifts from the transient period to a steady state, and PLL circuit 12 starts its PLL operation, tuning control signal Vt always becomes equal to or lower than its maximum potential Vtmax, and never exceeds Zener voltage Vz. Hence, Zener diode ZD does not make a breakdown operation due to its breakdown characteristics. Hence, in a steady state upon, e.g., tuning, high-quality reception free from any noise generated due to the breakdown characteristics of Zener diode ZD can be assured.

Furthermore, reception circuit 20 according to the present invention shown in FIG. 1 must be downsized as much as possible when it is assembled in cable modem M as a reception unit, as will be described later with reference to FIGS. 6 to 8. According to the present invention, as shown in FIG. 1, transistor Tr1 and PLL circuit 12 which serve as a control unit, oscillator 6, mixer 5, IF amplifier 14, and the like can be integrally formed as a chip of integrated circuit IC1. Hence, reception circuit 20 can be downsized, and can be built in cable modem M or the like.

<Other Arrangement Examples of Reception Circuit According to Embodiments of This Invention>

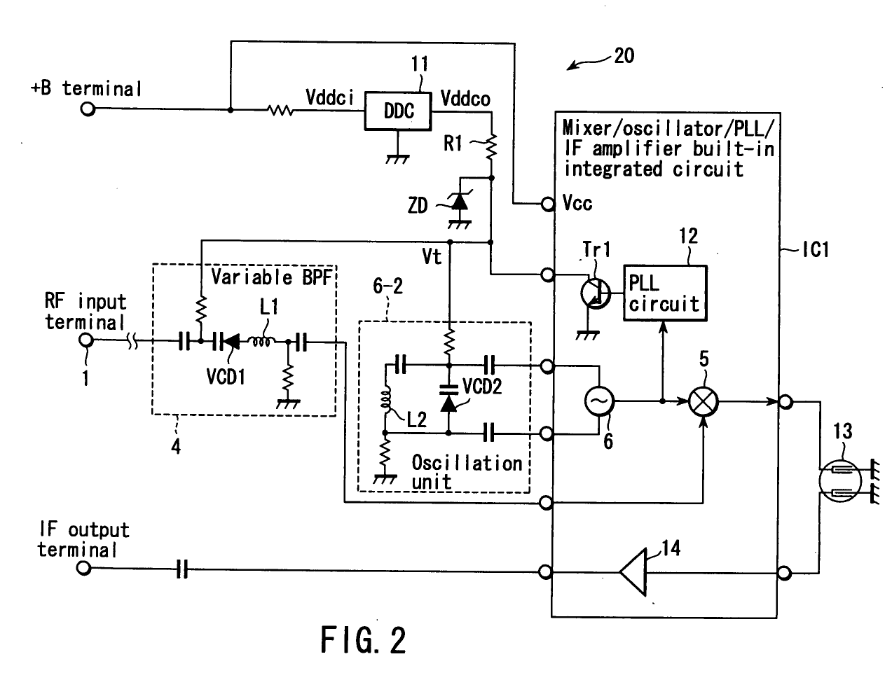

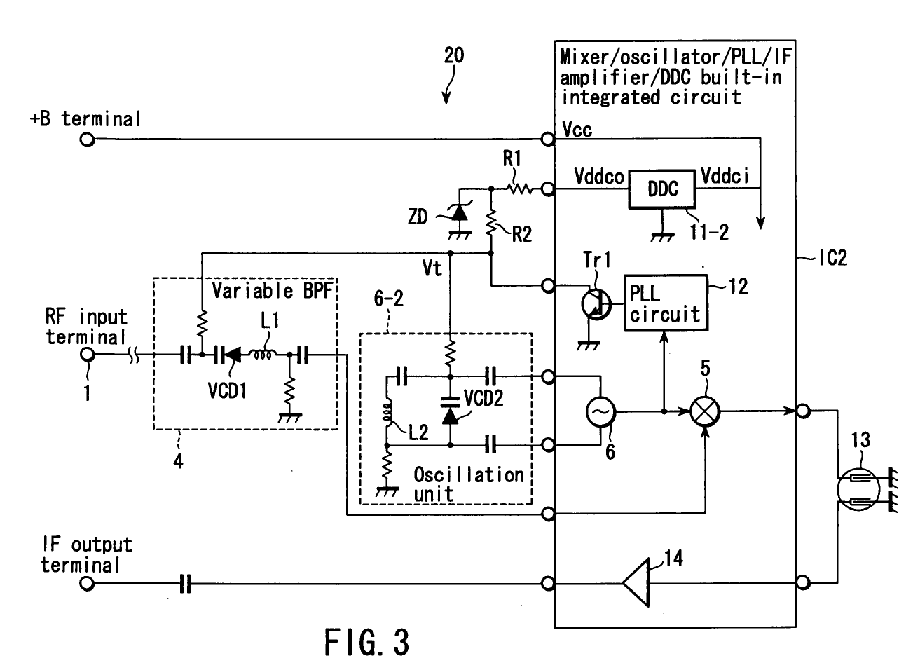

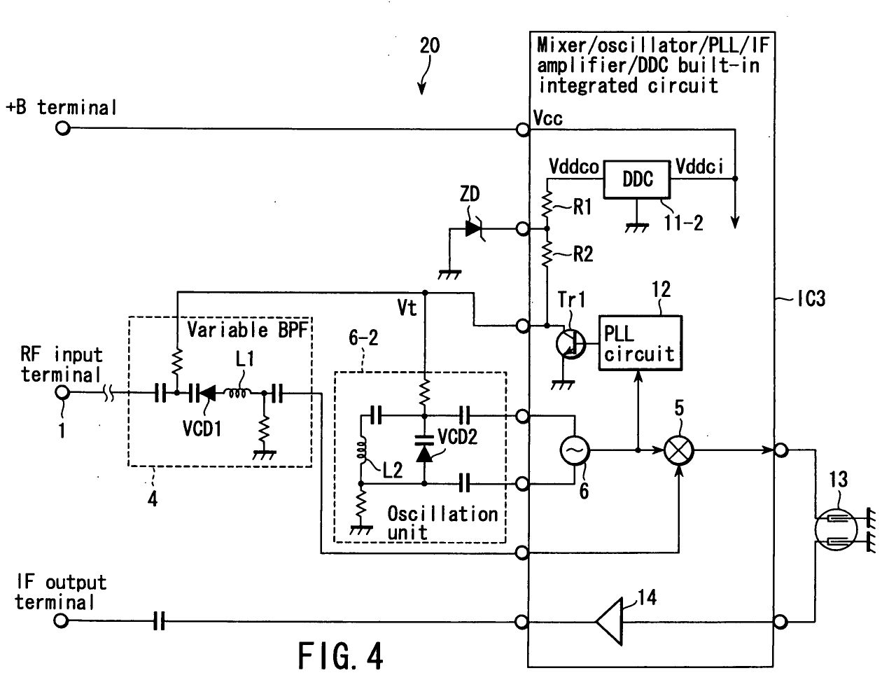

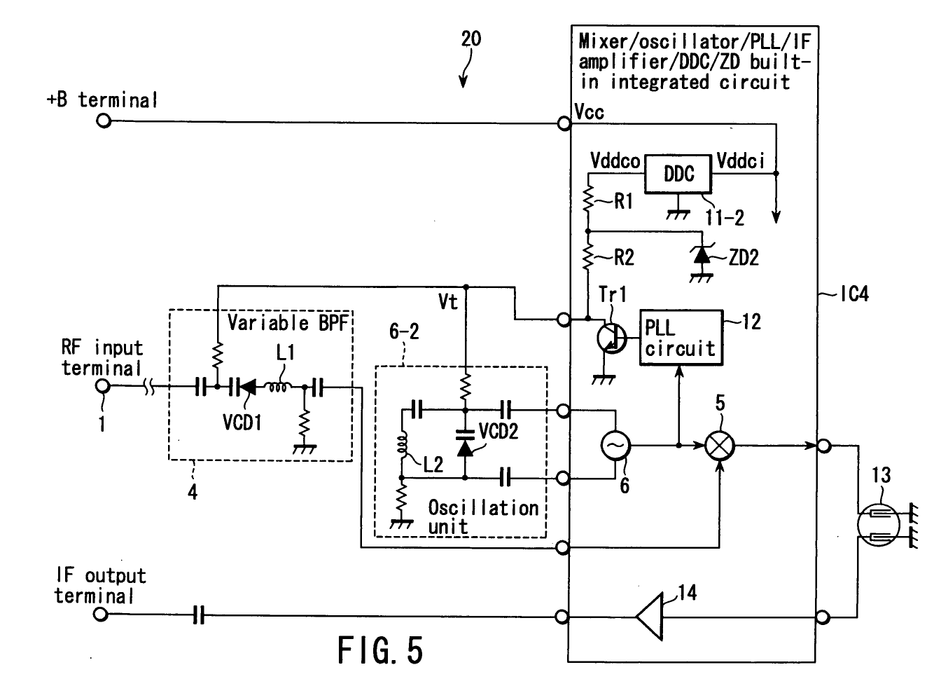

The reception circuit according to embodiments of the present invention can adopt not only the arrangement shown in FIG. 1 but also other effective arrangements. FIG. 2 is a block diagram showing the reception circuit according to the present invention, which uses only one voltage drop resistor. FIG. 3 is a block diagram of the reception circuit in which the DDC is formed in the integrated circuit. FIG. 4 is a block diagram of the reception circuit in which the DDC and resistors are formed in the integrated circuit. FIG. 5 is a block diagram of the reception circuit in which the DDC, resistors, and Zener diode are formed in the integrated circuit. Arrangements different from that in FIG. 1 will be mainly explained below.

Referring to FIG. 2, output voltage Vddco of DC-DC converter circuit 11 need not always be dropped using two resistor elements R1 and R2, as shown in FIG. 1, but may be dropped by only one resistor element R1, as shown in FIG. 2. In this way, reception circuit 20 can be simplified.

Referring to FIG. 3, DC-DC converter circuit 11-2 can be formed in integrated circuit IC2, thus achieving a further size reduction of the reception circuit.

Referring to FIG. 4, not only DC-DC converter circuit 11-2 but also two resistor elements R1 and R2 can be formed in integrated circuit IC3, thus achieving a further size reduction of the reception circuit.

Referring to FIG. 5, not only DC-DC converter circuit 11-2 and two resistor elements R1 and R2 but also Zener diode ZD2 can be formed in integrated circuit IC4, thus achieving a further size reduction of the reception circuit.

<Example of Broadcast Reception Apparatus According to Embodiments of This Invention>

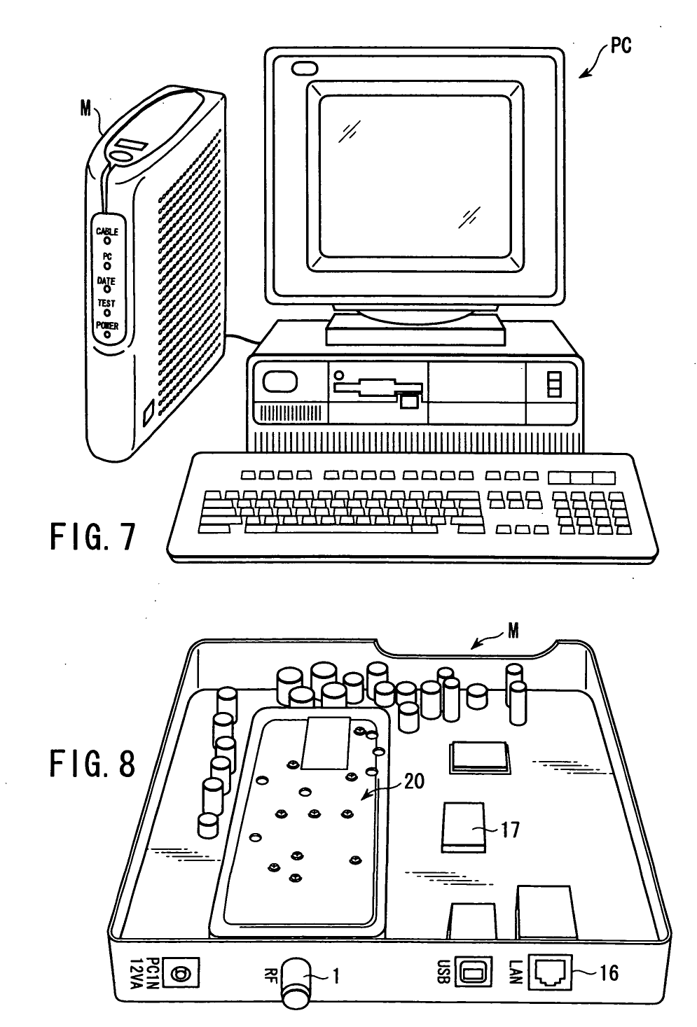

An example of broadcast reception apparatus M as a cable modem which incorporates the aforementioned reception circuit according to embodiments of the present invention as a reception unit will be described in detail hereinafter with reference to the accompanying drawings. FIG. 6 is a schematic block diagram showing the arrangement of an example of a broadcast reception apparatus according to the embodiment, FIG. 7 shows the outer appearance of an example of a PC connected to the broadcast reception apparatus according to the embodiment, and FIG. 8 shows the outer appearance of an example of a broad of the broadcast reception apparatus.

Referring to FIG. 6, broadcast reception apparatus M according to the embodiment has the aforementioned reception circuit as tuner unit 20, and also filter circuit unit 40, demodulation unit 30, and communication unit 50. Also, control unit 15 used to control the overall operations of these units is connected. Furthermore, RF input terminal 1 is connected to RF distributor 70 that supplies an RF signal via a cable. LAN terminal 16 connected to the communication unit is connected to, e.g., external PC (Personal Computer) 60 via network L.

In tuner unit 20, gain controller 2 which amplifies the gain of an RF signal supplied from RF input terminal 1, amplifier 3, band pass filter 4 mentioned above, mixer 5, and oscillation unit 6 that supplies an oscillation signal to mixer 5 are connected.

Furthermore, filter circuit unit 50 has SAW filter 13 as a band pass filter that filters an IF signal supplied from mixer 5, IF amplifier 14 that amplifies the filtered signal, and high pass filter (HPF) 43 that passes only high-frequency components.

Moreover, demodulation unit 30 has A/D converter 9 that A/D-converts the output from HPF 43, and digital demodulation circuit 10 that executes a digital demodulation process of the converted digital signal. The demodulated digital signal also undergoes error correction by an error correction circuit (not shown).

In addition, communication unit 50 includes, e.g., Ethernet interface 51, and has a normal network modem function. Communication unit 50 supplies a digital signal as the demodulated broadcast signal from demodulation unit 30 to, e.g., PC 60 mentioned above connected via network L.

FIG. 7 shows the outer appearance of an example of PC 60 and communication apparatus M according to the embodiment, which are connected via network L. When an Internet application or the like is launched on PC 60 connected to communication apparatus M shown in FIG. 7, a desired address such as a URL on the Internet is designated in accordance with a user's instruction to supply data according to this URL to communication apparatus M. Upon reception of this data, communication apparatus M transmits download request data of data at that URL in a frequency band designated by a CATV center station under the control of control unit 15.

After that, communication apparatus M tunes in accordance with the frequency band designated by the CATV center station using a tuning function of reception circuit 20 mentioned above, thus receiving digital communication data at the desired URL. The received digital communication data at the desired URL is demodulated by demodulation unit 30, and the demodulated data at the desired URL is supplied to PC 60 connected using network L via Ethernet I/F 51 of communication unit 50. In this way, the user can receive desired URL data on the Internet by PC 60 connected using network L via communication apparatus M having the modem function.

FIG. 8 shows the outer appearance of an example of the circuit board of communication apparatus M. In FIG. 8, communication apparatus M has a modem function having communication terminal 16 for, e.g., a LAN. Communication circuit 20 is provided as a unit bounded by a metal member so as to be isolated from, e.g., memory 17. Since communication circuit 20 is independently provided while being isolated by the metal member, quality deterioration, operation errors upon transmission/reception of communication circuit 20 due to the influences of high-frequency noise generated by memory 17 can be avoided.

With various embodiments described above, those who are skilled in the art can practice the present invention. Furthermore, those who are skilled in the can easily conceive various modifications of these embodiments, and can apply them to various embodiments even when they have no inventive skills. Therefore, the present invention covers a broad range that is consistent to the disclosed principle and novel features, and is not limited to the aforementioned embodiments.

As described in detail above, according to various embodiments of the present invention, in order to avoid the increased potential from the DC-DC converter circuit as a source of the control signal to be supplied to the selection unit of the reception circuit from becoming an excessive potential and destroying the variable capacitance diode upon, e.g., starting up a power supply, the increased voltage is suppressed by the Zener diode which has Zener voltage Vz higher than maximum potential Vtmax of the control signal. In an embodiment of the present invention, since no breakdown operation of the Zener diode is made in a steady state, satisfactory reception free from the influence of noise from the Zener diode can be assured. Also, the reception circuit can be downsized by forming some of its building components in the integrated circuit. Hence, a reception circuit that can be built in a network modem or the like, a broadcast reception apparatus, and a broadcast reception method can be provided.

What is claimed is:

1. A broadcast reception circuit comprising:
a selection unit configured to receive an RF signal, and to select a desired broadcast signal from the received RF signal in accordance with a predetermined control signal being input;
an amplifier unit configured to amplify the selected broadcast signal;
a booster unit configured to receive a power supply potential, and to increase the input power supply potential to output an increased potential;
a control unit responsive to the increased potential output from the booster unit, said control unit being configured to generate the control signal for designating the desired broadcast signal, so as to supply the control signal to the selection unit; and
a semiconductor Zener device which has a Zener voltage value larger than a maximum value of a potential of the control signal, and is configured to suppress or limit the increased potential supplied from the booster unit to be not more than the Zener voltage value.

2. A circuit according to claim 1, wherein the selection unit includes a band pass filter which allows the desired broadcast signal of the RF signal to pass through it using a variable capacitance diode in accordance with the control signal, and the Zener voltage value of the semiconductor Zener device is set to be smaller than a maximum rating of a reverse withstand voltage of the variable capacitance diode.

3. A circuit according to claim 2, wherein the selection unit includes an oscillation unit which outputs an oscillation signal of a specific frequency of the broadcast signal using a second variable capacitance diode in accordance with the control signal,
and wherein the Zener voltage value of the semiconductor Zener device is set to be smaller than a maximum rating of a reverse withstand voltage of the second variable capacitance diode.

4. A circuit according to claim 3, wherein the selection unit includes a mixer configured to mix a filtered signal of the RF signal, passing through the band pass filter, with the oscillation signal of the oscillation unit, so as to provide an IF signal.

5. A circuit according to claim 1, wherein one terminal of the semiconductor Zener device is connected to an output terminal of the booster unit via a resistor element, and other terminal thereof is configured to receive a circuit-ground potential.

6. A circuit according to claim 5, wherein at least one of said amplifier unit, said control unit, and said resistor element is formed in an integrated circuit.

7. A circuit according to claim 1, wherein one terminal of the semiconductor Zener device is connected to an output terminal of the booster unit via a first resistor element, other terminal thereof is configured to receive a circuit-ground potential, and a second resistor element is inserted between the one terminal of the semiconductor Zener device and the control unit.

8. A circuit according to claim 1, wherein the booster unit is configured to include a DC-DC converter.

9. A circuit according to claim 1, wherein the booster unit is configured to be formed in an integrated circuit.

10. A circuit according to claim 1, wherein the control unit is configured to include a transistor to which the increased potential from the booster unit is applied, and from which the control signal is obtained, by driving the transistor with a PLL circuit in accordance with a frequency of the desired broadcast signal.

11. A circuit according to claim 1, further comprising a communication unit configured to receive an amplified output from the amplifier unit, and to transmit the received amplified output via a network.

12. A broadcast reception apparatus comprising:
a selection unit configured to receive an RF signal, and to select a desired broadcast signal from the received RF signal in accordance with a predetermined control signal being input;
an amplifier unit configured to amplify the selected broadcast signal;
a booster unit configured to receive a power supply potential, and to increase the input power supply potential to output an increased potential;
a control unit responsive to the increased potential output from the booster unit, said control unit being configured to generate the control signal for designating the desired broadcast signal, so as to supply the control signal to the selection unit;
a semiconductor Zener device which has a Zener voltage value larger than a maximum value of a potential of the control signal, and is configured to suppress or limit the increased potential supplied from the booster unit to be not more than the Zener voltage value; and
a demodulation unit configured to demodulate an amplified output from the amplifier unit so as to output a demodulated signal.

13. A broadcast reception system comprising:
receiving an RF signal, and selecting a desired broadcast signal from the received RF signal in accordance with a predetermined control signal being input;
amplifying the selected broadcast signal;
increasing an input power supply potential to output an increased potential;
responsive to the increased potential, generating the control signal, used to designate the desired broadcast signal, so as to supply the control signal; and
suppressing or limiting the increased potential to be not more than a given Zener voltage value which is larger than a maximum value of a potential of the control signal.
